(19) United States
(12) Patent Application Publication
(10) Pub. No.: US 2018/0087318 A1
(43) Pub. Date: Mar. 29, 2018

(54) TENSION BLIND

(71) Applicant: NIEN MADE ENTERPRISE CO., LTD., Taichung (TW)

(72) Inventors: YU-CHE WEN, Taoyuan County (TW); XU-WU QU, Taichung City (CN)

(21) Appl. No.: 15/477,708

(22) Filed: Apr. 3, 2017

(30) Foreign Application Priority Data
Sep. 28, 2016 (CN) 201621087282.4

(51) Int. Cl. E06B 9/326; E06B 9/324

(52) U.S. Cl. CPC E06B 9/326; E06B 2009/3265; E06B 9/324

(57) ABSTRACT

A tension blind including a covering structure, a movable rail, two lifting cords, and two fixing units is disclosed. Each of the lifting cords is connected to a first fixture with an end, passes through the covering structure and the movable rail, and is connected to a fixing unit installed on a second fixture with the other end. The fixing unit includes a connected member fixed to the second fixture, and a connecting member which is connected to an end of the lifting cord and to the connected member detachably. If the lifting cord is forced by a non-vertical pull greater than a preset combined value between the connecting member and the connected member, the connecting member is automatically disconnected from the connected member in order to release the lifting cord.

### BACKGROUND OF THE INVENTION

### 1. Technical Field

The present disclosure relates generally to a window blind, and more particularly to a tension blind.

### 2. Description of Related Art

A conventional tension blind includes a lifting cord fixed to a headrail with an end, passing through a covering structure (e.g., slats) and a bottom rail, and fixed to a window frame below the bottom rail with the other end. By moving the bottom rail along the lifting cord, a user can control the bottom rail to stop at any position on the lifting cord through a friction between the lifting cord and the bottom rail.

When the bottom rail is moved close to the headrail, an unsightly appearance will be presented if the lifting cord is obviously exposed to a region encircled by the window frame. To prevent such situation, the lifting cord of a conventional tension blind passes through the bottom rail from the top which is close to the middle of the bottom rail, to the bottom which is close to the end of a long axis of the bottom rail. In other words, the lifting cord bends within the bottom rail. Whereby, when the bottom rail is moved close to the headrail, the exposed segment of the lifting cord will be close to the side wall of the window frame, and will not be easily observed.

However, the gap between the lifting cord and the side wall of the window frame might pose a life-threatening danger. More specifically, if a child inadvertently puts his head through the gap, and struggles to break away, the lifting cord would wrap around the child's neck.

### BRIEF SUMMARY OF THE INVENTION

In view of the above, the primary objective of the present disclosure is to provide a tension blind which can trigger a safety mechanism when being forced by a non-vertical pull under a normal usage condition.

The present disclosure provides a tension blind including a covering structure, a movable rail, at least one lifting cord, at least one connected member, and at least one connecting member. Each of the at least one lifting cord is connected to a first fixture with an end thereof, and passes through the covering structure and the movable rail, and is connected to a second fixture with another end thereof. Each of the at least one connected member is fixed to the second fixture and has a connected portion. Each of the at least one connecting member has a first connecting portion and a second connecting portion. The first connecting portion is connected to the another end of the at least one lifting cord. The second connecting portion is detachably connected to the connected portion.

The present disclosure further provides a tension blind including a covering structure, a movable rail, at least one lifting cord, at least one connected member, and at least one connecting member. Each of the at least one lifting cord is connected to a first fixture with an end thereof, and passes through the covering structure and the movable rail, and is connected to a second fixture with another end thereof. Each of the at least one connected member is fixed to the second fixture and has a connected portion. Each of the at least one connecting member has a first connecting portion and a second connecting portion. The first connecting portion is connected to the another end of the at least one lifting cord. If the lifting cord forces the connecting member with a pull which is not parallel to the axis, the second connecting portion is detached from the connected portion.

Whereby, if the lifting cord is forced by the non-vertical pull, the lifting cord will move the connecting member to disconnect the connecting member from the connected member so as to prevent accidents.

### BRIEF DESCRIPTION OF THE SEVERAL VIEWS OF THE DRAWINGS

The present disclosure will be best understood by referring to the following detailed description of some illustrative embodiments in conjunction with the accompanying drawings, in which

FIG. 1 is a perspective view of a first embodiment of the present disclosure, showing the tension blind;

FIG. 2 is a front view of the tension blind in FIG. 1;

FIG. 3 is a partially enlarged view of the tension blind in FIG. 1;

FIG. 4 is a partially perspective view of the tension blind in FIG. 1, showing the connecting member and the connected member;

FIG. 5 is a perspective view of the connecting member in FIG. 4;

FIG. 6 is a sectional view of the connecting member and the connected member in FIG. 4, showing the connecting member and the connected member are connected;

FIG. 7 is a front view of the tension blind in FIG. 2, showing the movable rail is moved toward the fixed rail;

FIG. 8 is a sectional view of the connecting member and the connected member in FIG. 6, showing the connecting member is pulled upward by the lifting cord;

FIG. 9 is a partially perspective view of a second embodiment, showing the connecting member and the connected member;

FIG. 10 is a perspective view of the connecting member in FIG. 9;

FIG. 11 is a sectional view of the connecting member and the connected member in FIG. 9, showing the connecting member and the connected member are connected;

FIG. 12 is a partially exploded view of a third embodiment, showing the connecting member and the connected member;

FIG. 13 is a perspective view of the connecting member and the connected member in FIG. 12, showing the connection between the connecting member and the connected member;

FIG. 14 is a sectional view along the 14-14 line in FIG. 13;

FIG. 15 is a sectional view along the 15-15 line in FIG. 13;

FIG. 16 is a perspective view of the connecting member and the connected member of a fourth embodiment, showing the connection between the connecting member and the connected member;

FIG. 17 is an exploded view of the connecting member and the connected member in FIG. 16;

FIG. 18 is a sectional view of FIG. 16, showing the connecting member and the connected member are connected;

FIG. 19 is a front view of the fourth embodiment, showing the foreign body is stretched between the lifting cord and the window frame;

FIG. 20 is a front view of the tension blind in FIG. 19, showing the foreign body is stretched between the two lifting cords;

FIG. 21 is a perspective view of the connecting member and the connected member of a fifth embodiment, showing the connection between the connecting member and the connected member; and

FIG. 22 is a sectional view of FIG. 21, showing the connecting member and the connected member are connected.

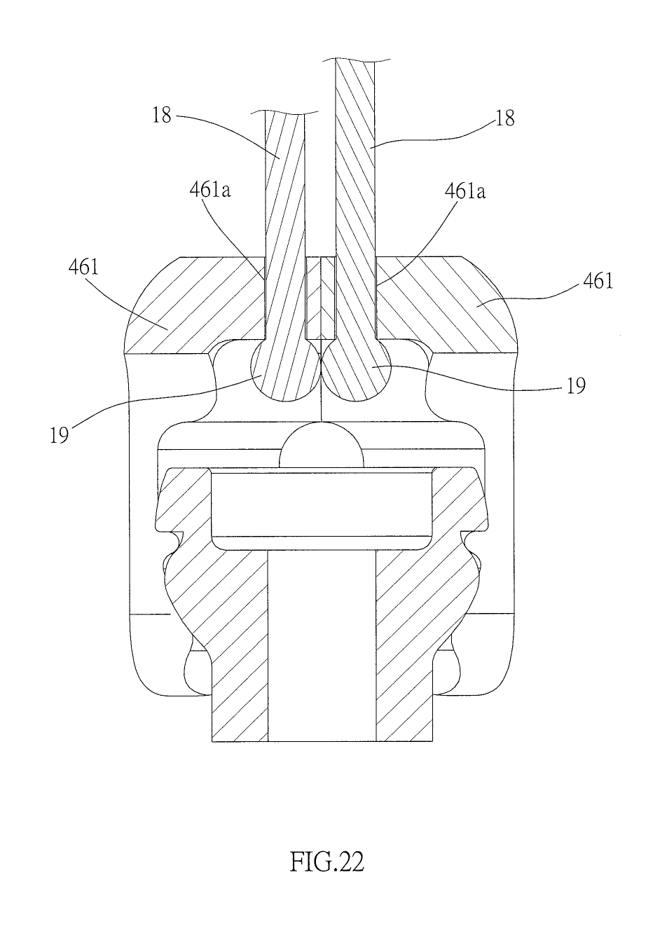

### DETAILED DESCRIPTION OF THE INVENTION

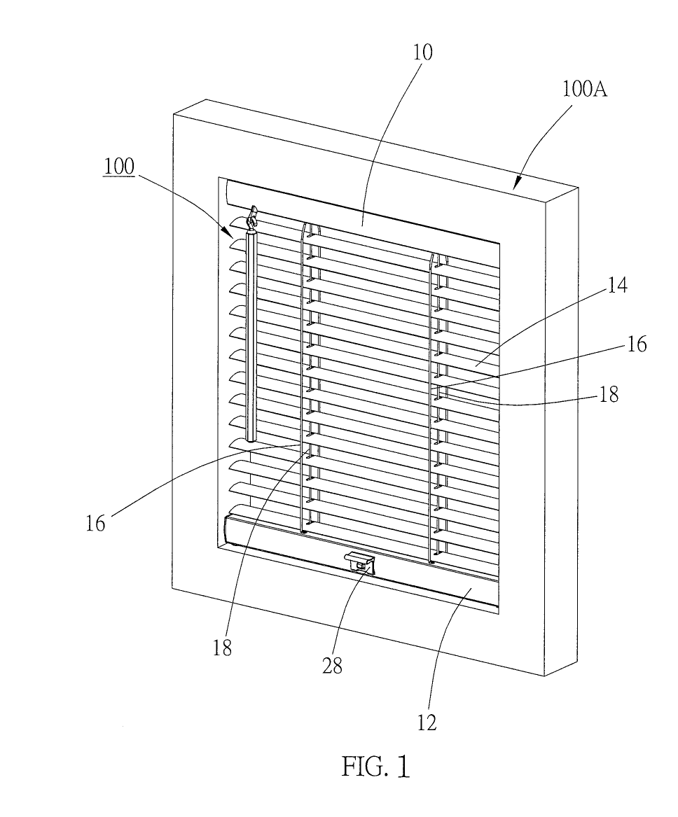

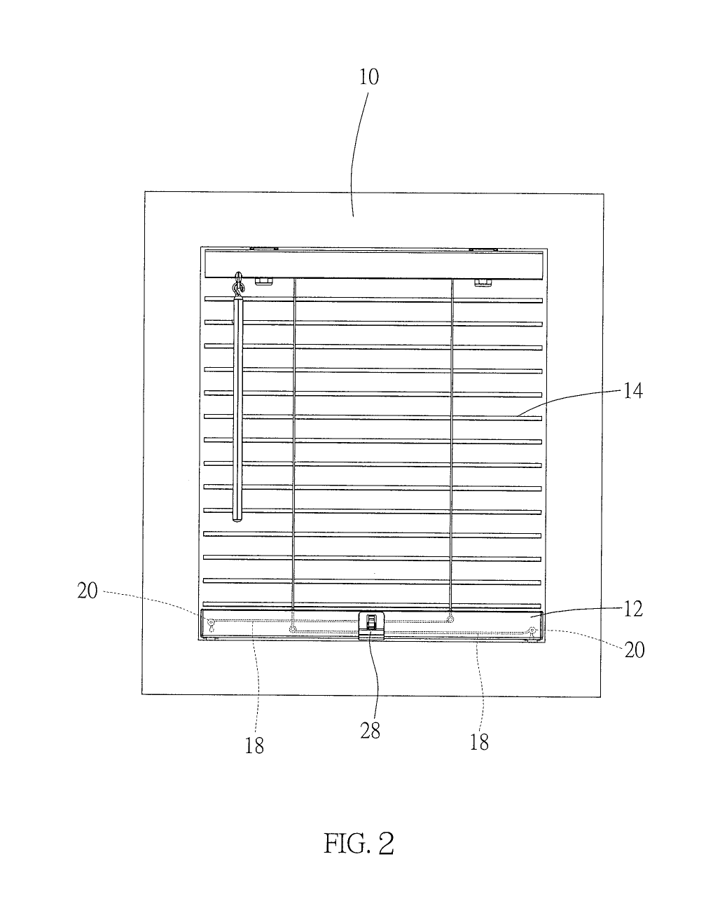

As shown in FIG. 1 and FIG. 2, a tension blind 100 is installed in a window frame 100A and includes a fixed rail 10, a movable rail 12, and a covering structure which are a plurality of slats 14 in the first embodiment, while in other embodiments, the covering structure is not limited to the slats. The slats 14 are parallel and hung between the fixed rail 10 and the movable rail 12 through two ladder ropes 16. The movable rail 12 is movable along two lifting cords 18 relative to the fixed rail 10 for expanding or collecting the window blind 100.

Each of the lifting cords 18 is connected to the fixed rail 10 (i.e., the first fixture defined in the present disclosure) with an end thereof, passes through the slats 14 and the movable rail 12 in sequence, winds around the divert wheel 20 that is installed close to the end of the long axis of the movable rail 12, and is connected to a fixing unit that is installed on a side at the bottom of the window frame 100A with the other end thereof, which makes the lifting cords 18 indirectly connected to the window frame 100A (i.e., the second fixture defined in the present disclosure), wherein the lifting cords 18 are taut. By moving the movable rail 12 along the lifting cords 18, a user can control the movable rail 12 to stop at any position on the lifting cords 18 through a friction between the lifting cords 18 and the movable rail 12. However, in other embodiments, the first fixture is not limited to the fixed rail 10 but can be a window frame or a wall according to the requirements for installation and product design.

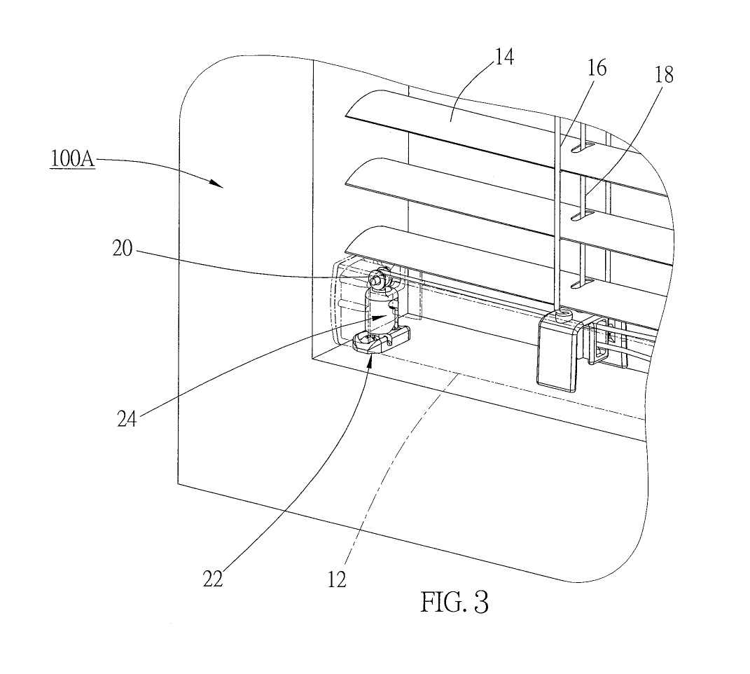

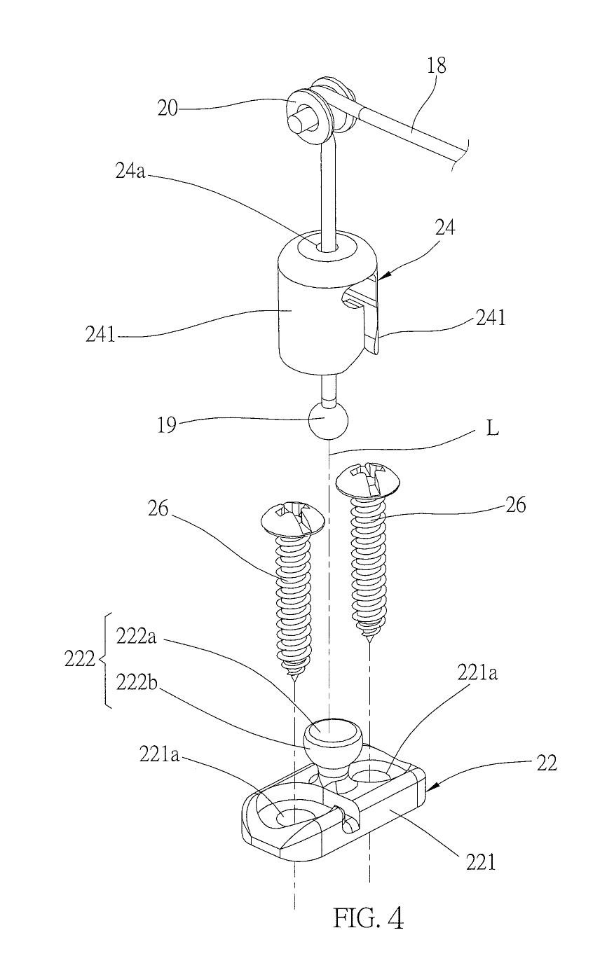

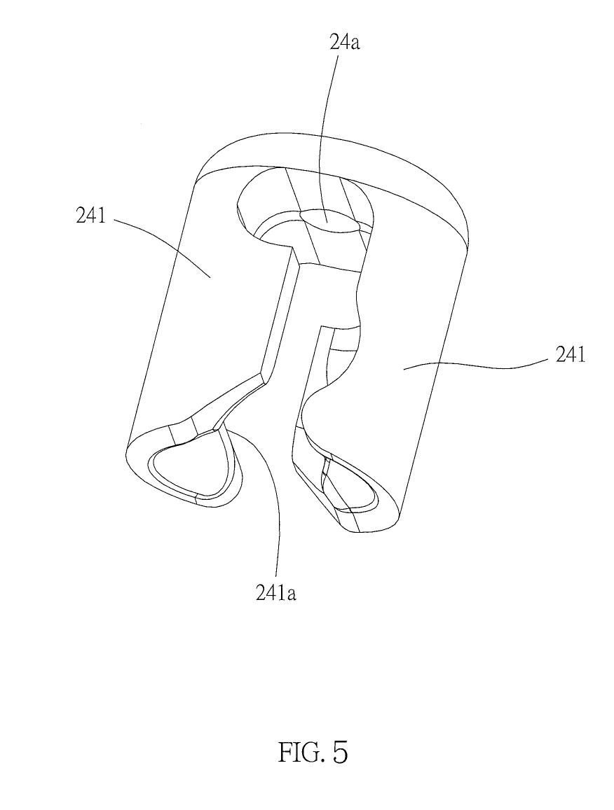

As shown in FIG. 3 to FIG. 6, each of the fixing unit includes a connected member 22, a connecting member 24, and two screws 26, wherein the connected member 22 includes a base 221 and a protrusion 222. In the first embodiment, the base 221 is a substantially rectangular block and has two perforations 221a each communicates the top surface with the bottom surface thereof, wherein each of the perforation 221a is a step bore with different bore diameters. The protrusion 222 is integrally formed on the base 221 between the two perforations 221a, and has a spherical body 222a, wherein the spherical body 222a has an abutted surface 222b on the lower part thereof facing the base 221, wherein the abutted surface 222b is the connected portion defined in the present disclosure. The two screws 26 pass through the perforations 221a correspondingly, and the head of the screw 26 is located within a step of the perforation 221a having a greater bore diameter. The connected member 22 is fixedly connected to the window frame 100A after the screws 26 are tightened into the window frame 100A.

The connecting member 24 of the fixing unit includes a first connecting portion and a second connecting portion. The first connecting portion is connected to the end of the lifting cord 18 stretching out from the bottom of the movable rail 12; the second connecting portion is detachably connected to the connected portion of the connected member 22. In the first embodiment, the connecting member 24 is a hollow cylinder having an axis L, wherein the wall of the hollow cylinder consists of two arc-shaped flexible members, and a space is formed between the two flexible members; the flexible members are two flexible pieces 241 with the same structure, which are provided symmetrically. In the current embodiment, each of the flexible pieces 241 of the connecting member 24 is a shell including an arc-shaped surface. In addition, the top edges of the two flexible pieces 241 are integrally formed, and the connecting member 24 has a hole 24a at the top, which is the first connecting portion defined in the present disclosure; preferably, the hole 24a is aligned with the axis L. The bottom edges of the two flexible pieces 241 are free ends so that the flexible pieces 241 can be deformed by forces. Moreover, the inner wall of each of the flexible pieces 241 is protruded inward to form an abutting surface 241a that is the second connecting portion defined in the present disclosure. The abutting surface 241a is corresponding to the lower part of the spherical body 222a of the connected member 22 (i.e., abutted surface 222b), and is concave for abutting against the abutted surface 222b, in order to prevent the connecting member 24 from being detached from the connected member 22.

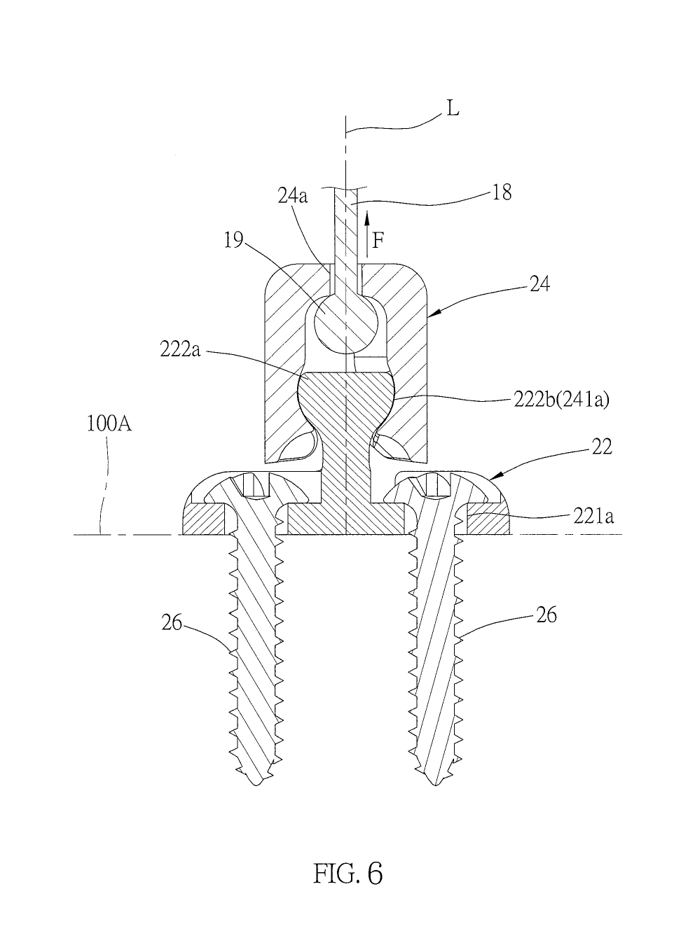

As illustrated in FIG. 6, the lifting cord 18 vertically passes through the hole 24a of the connecting member 24 with an end thereof, and a block portion 19 is formed by a knot of the lifting cord 18 or connecting another object to the end of the lifting cord 18, wherein a diameter of the block portion 19 is greater than a hole diameter of the hole 24a so that the lifting cord 18 fails to be loosed from the connecting member 24. Furthermore, the lifting cord 18 is connected to the fixed rail 10 with an end thereof, that is, the lifting cord 18 pulls the connecting member 24 by a force having a direction parallel or equal to the axis L, which keeps the lifting cord 18 taut, and makes the movable rail 12 smoothly movable along the lifting cord 18 by force from users.

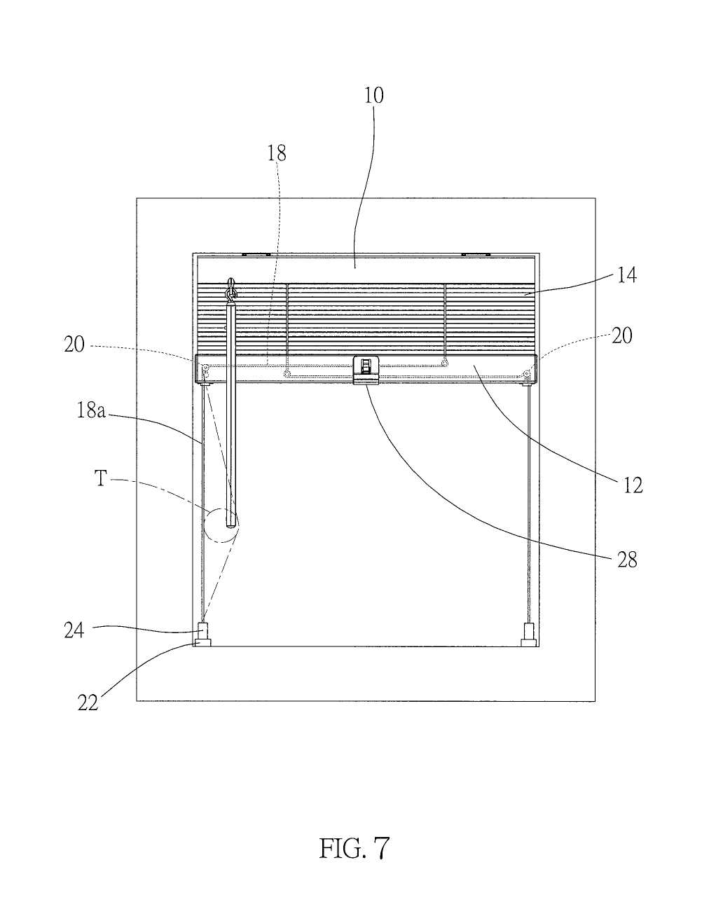

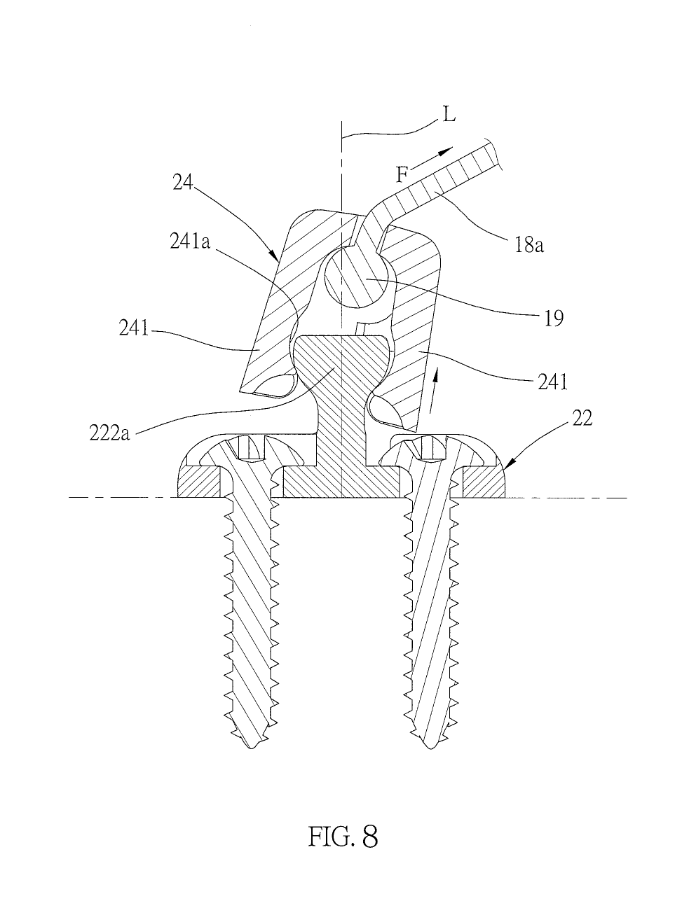

It is shown in FIG. 7 that the movable rail 12 is moved toward the fixed rail 10, and the slats 14 are close and stacked. Because the lifting cord 18 is connected to the connecting member 24 after winding around the divert wheel 20, an exposed segment 18a that is no longer covered by the movable rail 12 is close to the vertical side wall of the window frame 100A. FIG. 8 further shows the lifting cord 18 and the connecting member 24 under a tightened state when the lifting cord 18 is forced by a non-vertical pull F which is a non-positive pull to the connecting member 24. If a foreign body T (e.g., child's head) is inadvertently stretched between the side wall of the window frame 100A and the exposed segment 18a of the lifting cord 18, the exposed segment 18a will be forced to be tightened bow-shaped (the phantom line shown in FIG. 7). In such situation, the lifting cord 18 is forced by a lateral force so that the pull F applying to the connecting member 24 deviates from the original direction of the axis L of the connecting member 24. Thus, the connecting member 24 is obliquely pulled up, and positions abutting against the spherical body 222a of the connected member 22 on the protruded part of the inner wall of the flexible pieces 241 changes corresponding to the displacement of the connecting member 24. In more details, the abutting surface 241a of one of the flexible pieces 241 abuts against the abutted surface 222b on the lower part of the spherical body 222a, while the bottom of the other flexible piece 241 is expanded outward due to the oblique pull. If the non-vertical pull F is greater than a preset combined value between the connecting member 24 and the connected member 22, the connecting member 24 will be automatically disconnected from the connected member 22, which releases the exposed segment 18a of the lifting cord 18 below the movable rail 12 in order to avoid the hazard that the lifting cord 18 wraps around a neck.

The movable rail 12 is controllable to stop at any position by the guiding of the lifting cords 18; moreover, the tension blind 100 has a lifting cord locking mechanism 28 (shown in FIG. 1) provided on the movable rail 12 to ensure the movable rail 12 stopping at any position without descending in a manner that does not interfere with the action of the movable rail 12. Even if the exposed segment 18a of the lifting cord 18 is released, the segment between the fixed rail 10 and the lifting cord locking mechanism 28 is still taut due to the intervening of the lifting cord locking mechanism 28, which prevents the movable rail 12 from descending or inclining. Various practical structures of the lifting cord locking mechanism 28 are disclosed in a Chinese patent application No. 201620518789.4, lifting cord locking mechanism for window covering, and thus are not described herein.

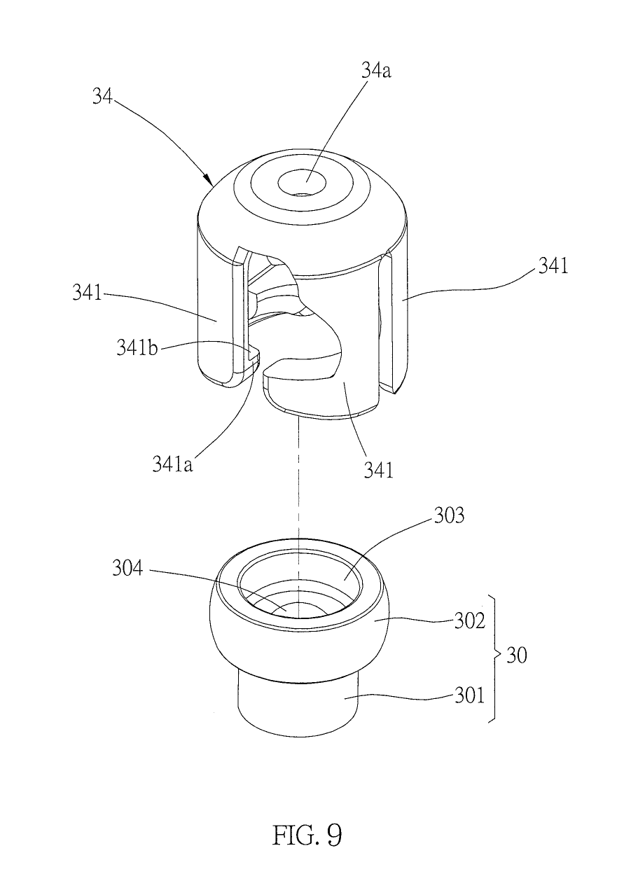

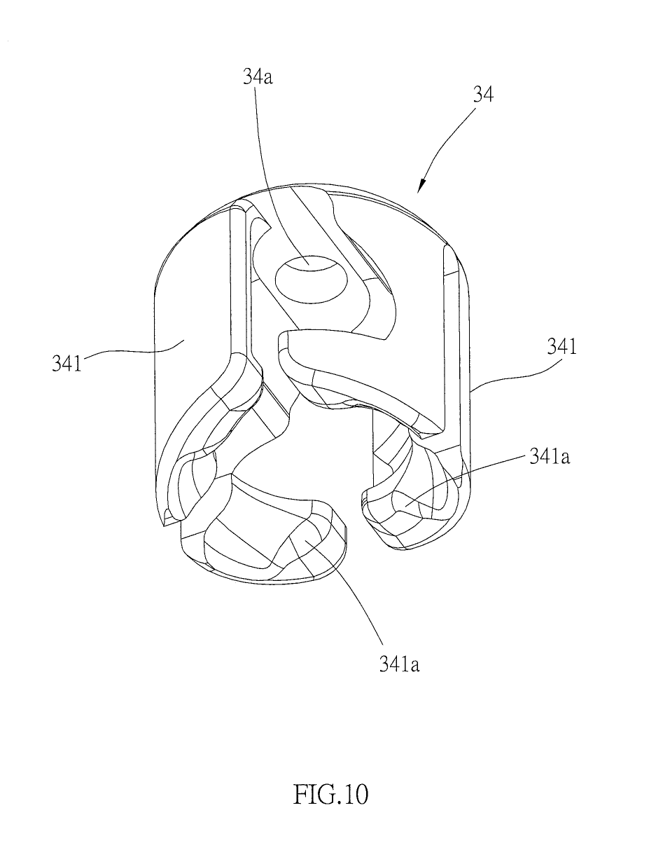

Furthermore, the structure of the fixing unit triggering the safety mechanism is not limited to that in the first embodiment but can be other types described below. As shown in FIG. 9 to FIG. 11, the connected member 30 of the second embodiment includes a base 301 and a protrusion 302, wherein the connected member 30 is substantially a cylinder. The difference between the connected member 30 and the connected member 22 is, an outer diameter of the protrusion 302 is greater than that of the base 301, and thus an abutted surface 302a is formed on the bottom surface of the protrusion 302. In addition, the connected member 30 has a bore 303 recessed from the top surface of the protrusion 302, and a perforation 304 passing through the base 301 and communicating the bore 303, wherein a diameter of the bore 303 is greater than that of the perforation 304. A screw 32 passes through the bore 303 and the perforation 304 and is screwed into the window frame 100A. In addition, the head of the screw 32 tightly abuts against a bottom surface of the bore 303 so that the connected member 30 is fixedly connected to the window frame 100A. The connecting member 34 is a hollow cylinder and has an axis L, wherein the wall of the connecting member 34 consists of four arc-shaped flexible pieces 341. In the current embodiment, each of the flexible pieces 341 of the connecting member 34 is a shell including an arc-shaped surface. Additionally, the connecting member 34 has a hole 34a at the top to let the lifting cord 18 pass through. The inner wall of each of the flexible pieces 341 is protruded inward to form a hook 341a which has an abutting surface 341b.

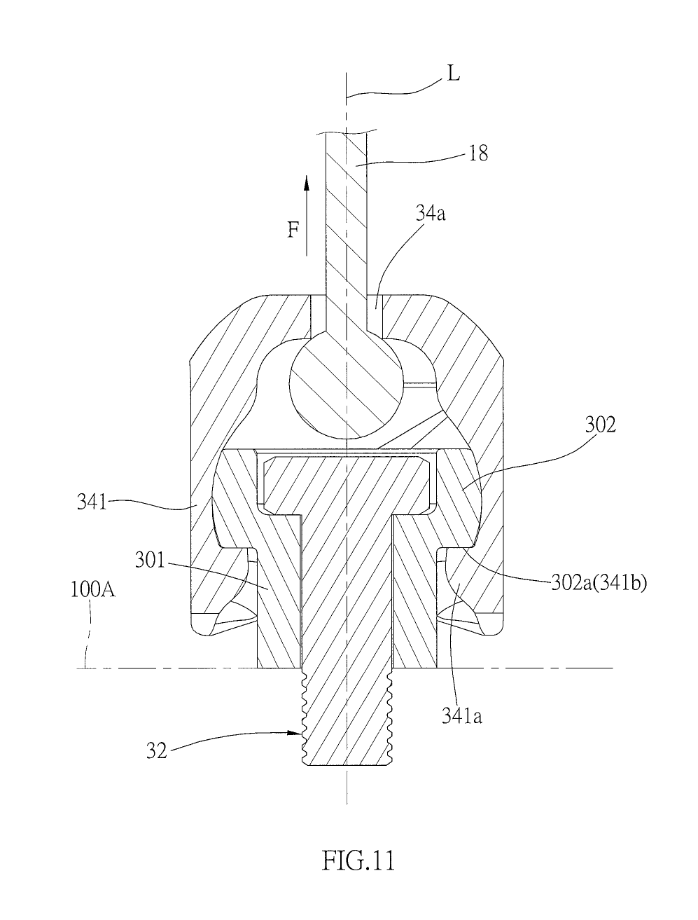

As shown in FIG. 11, in a normal usage condition, the connecting member 34 covers the connected member 30 with the flexible pieces 341 thereof. Moreover, the flexible piece 341 abuts against the abutted surface 302a of the protrusion 302 of the connected member 30 with the abutting surface 341b of the hook 341a thereof. Therefore, the protrusion 302 confines the connecting member 34 to be firmly connected to the connected member 30 when the lifting cord 18 pulls the connecting member 34 by a force F having a direction parallel or equal to the axis L, and before the connecting member 34 is forced by the non-vertical pull F. Similarly, when being forced by the lateral force, the lifting cord 18 pulls the connecting member 34 with the non-vertical pull F which deviates from the original direction of the axis L of the connecting member 34 rather than being parallel to the original direction of the axis L. If said non-vertical pull F is greater than a preset combined value between the connecting member 34 and the connected member 30, the abutting surface 341b on the hook 341a of at least one of the arc-shaped flexible pieces 341 of the connecting member 34 is detached from the abutted surface 302a of the protrusion 302 of the connected member 30. Accordingly, the flexible piece 341 is deformed outward, and thus the connecting member 34 is automatically disconnected from the connected member 30, which releases the lifting cord 18.

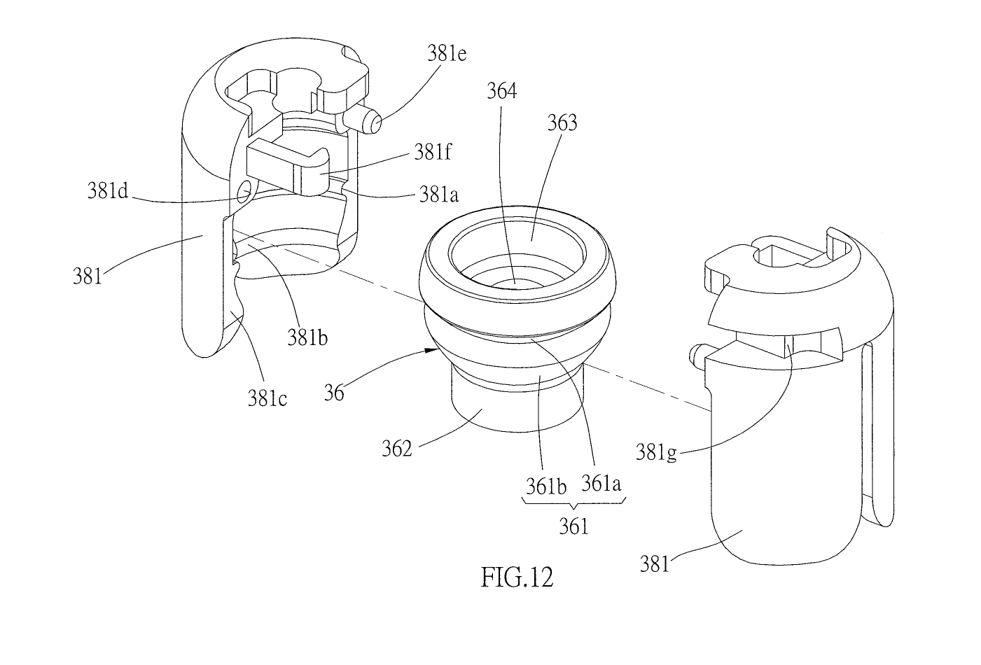

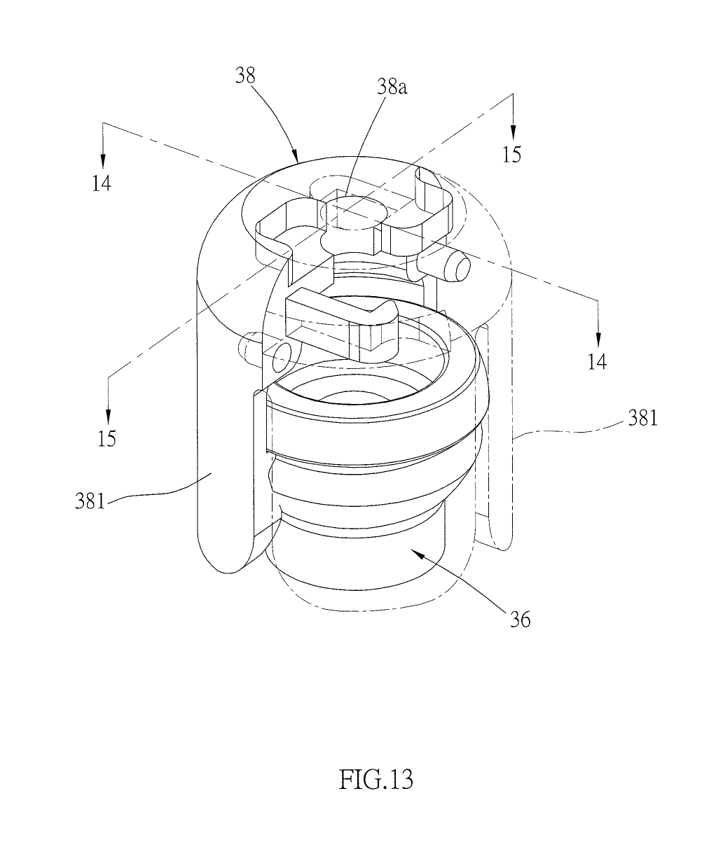

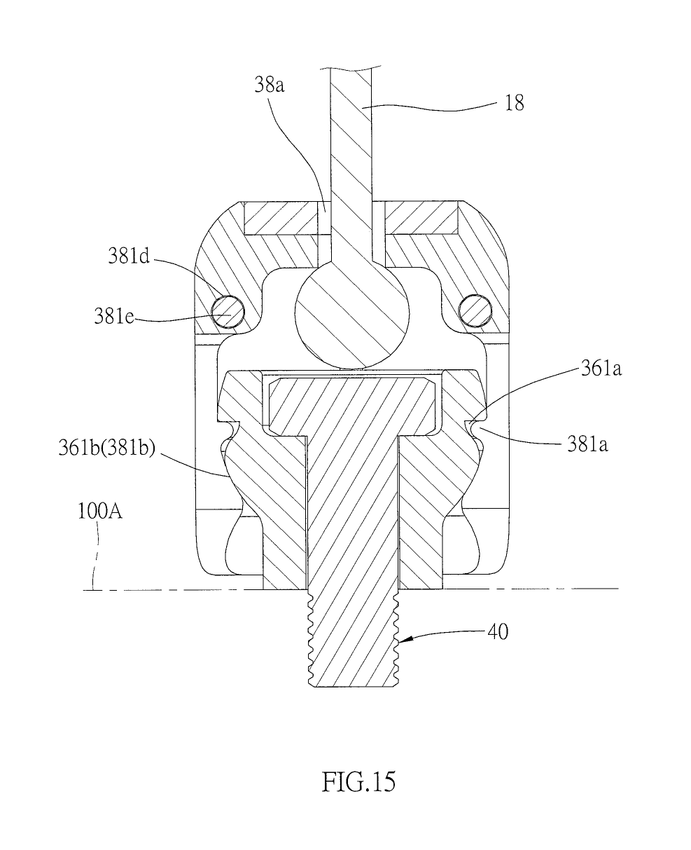

As shown in FIG. 12 to FIG. 15, the fixing unit includes a connected member 36 and a connecting member 38. The connected member 36 also includes a protrusion 361, a base 362, a bore 363, and a perforation 364. The protrusion 361 is a spherical body with an outer diameter greater than an outer diameter of the base 362. In addition, the protrusion 361 has a ring groove 361a and an abutted surface 361b formed on the lower part of the protrusion 361. The base 362 is provided below and connected to the protrusion 361. The bore 363 and the perforation 364 jointly pass through the protrusion 361 and the base 362. A screw 40 passes through the bore 363 and the perforation 364 and is screwed into the window frame 100A. Additionally, the head of the screw 40 tightly abuts against the bottom surface of the bore 363 so that the connected member 36 is fixedly connected to the window frame 100A.

The connecting member 38 has an axis L and includes two flexible pieces 381 with the same structure, wherein each of the flexible pieces 381 is a semicircular shell. In the current embodiment, each of the flexible pieces 381 of the connecting member 38 is a shell including an arc-shaped surface. The two flexible pieces 381 are detachably connected, and each of the flexible pieces 381 forms a hole 38a at the top, wherein the hole 38a is configured to let an end of the lifting cord 18 pass through, and is the first connecting portion defined in the present disclosure. Similarly, the hole 38a is aligned on the axis L preferably. Each of the flexible pieces 381 has a rib 381a protruding from the middle of the inner wall thereof, and the inner wall is protruded inward to form an abutting surface 381b near the bottom of the flexible piece 381, wherein the abutting surface 381b is the second connecting portion defined in the present disclosure. Furthermore, each of the flexible pieces 381 has a connecting surface 381c, a positioning bore 381d recessed from an upper section of the connecting surface 381c, and a positioning pin 381e protruding from the connecting surface 381c. Additionally, each of the flexible pieces 381 further has a hook 381f and a hooked portion 381g formed above the positioning bore 381d and the positioning pin 381e.

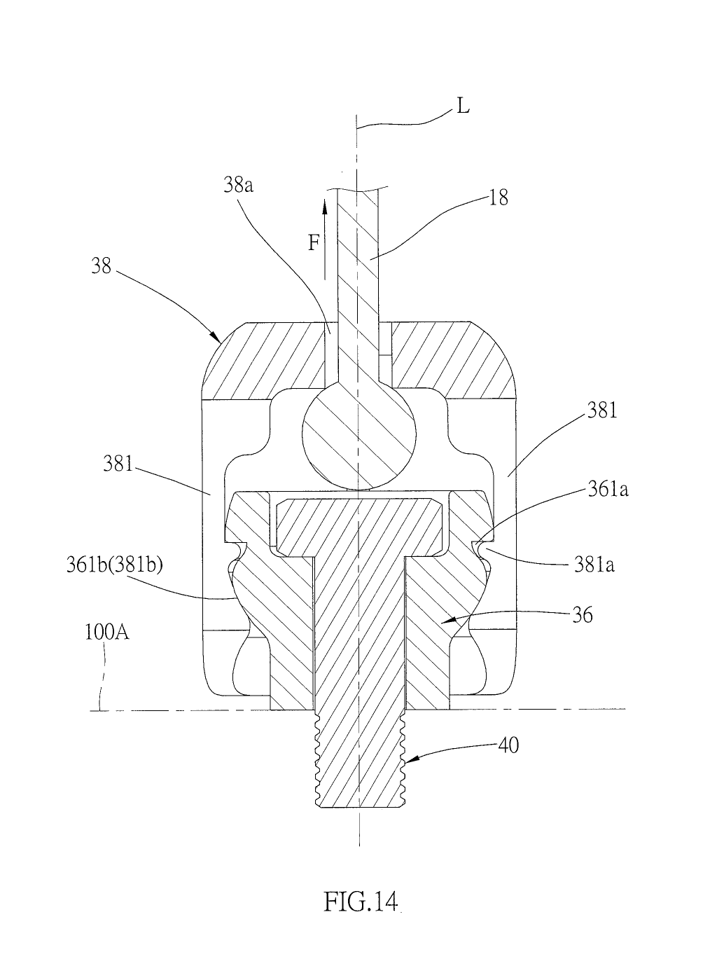

The two flexible pieces 381 cover the connected member 36 by pressing the connected member 36 from both sides. More specifically, the positioning pin 381e of one of the flexible pieces 381 is inserted into the positioning bore 381d of the other flexible piece 381, and the hook 381f of one of the flexible pieces 381 clasps the hooked portion 381g of the other flexible piece 381. Accordingly, the connecting surfaces 381c of the flexible pieces 381 abut against each other so that the rib 381a is embedded into the groove 361a, and the abutting surface 381b of each flexible piece 381 abuts against the abutted surface 361b of the protrusion 361. In this way, the connecting member 38 is firmly fixed to the connected member 36. In addition, if the connecting member 38 is forced by a vertical pull F which is parallel or equal to the axis L depicted in FIG. 14, the rib 381a embedded into the groove 361a will abut against the upper wall of the groove 361a so that the connecting member 38 can be firmly fastened to the connected member 36. However, in other embodiments, the ring groove 361a is replaced by a plurality of grooves that are respectively corresponding to each rib 381a. similarly, if the connecting member 38 is forced by a non-vertical pull (not shown) from the lifting cord 18, and if said non-vertical pull is greater than a preset combined value between the connecting member 38 and the connected member 36, the rib 381a will thus incline and be disconnected from the upper wall of the groove 361a. Next, the flexible pieces 381 are deformed in the radial direction thereof, so that the connecting member may separate 38 from the connected member 36. In such situation, the flexible pieces 381 keep connected by the horizontally fastening force between the hook 381f and the hooked portion 381g, rather than disconnected by the non-vertical pull.

The numbers of the flexible members of the aforementioned embodiments are two or four, but can be other numbers in other embodiments according to different designs as long as the connecting member and the connected member are firmly connected when fastened together, while if the lifting cord pulls the connecting member by a non-vertical force, the flexible member can be flexibly deformed to be disconnected from the connected member.

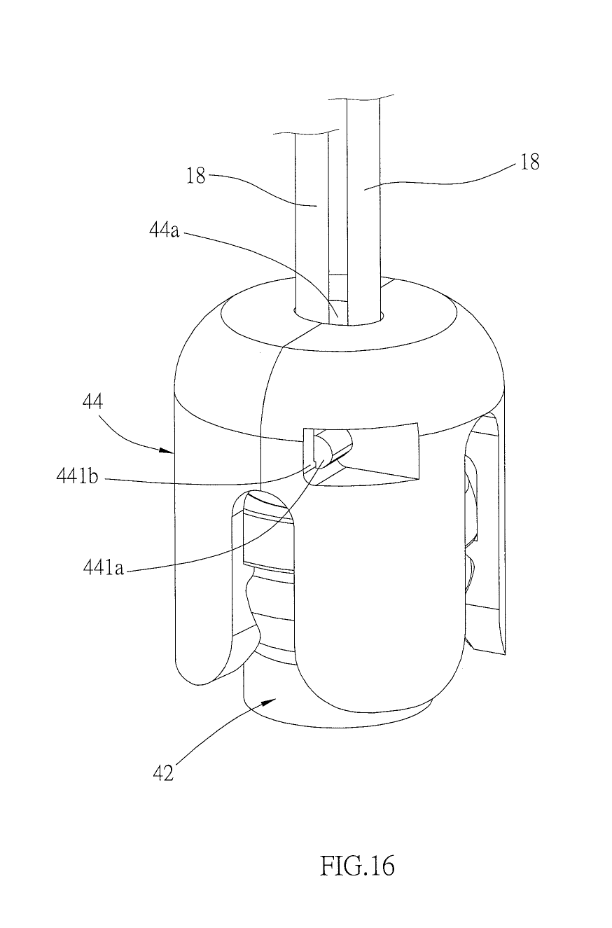

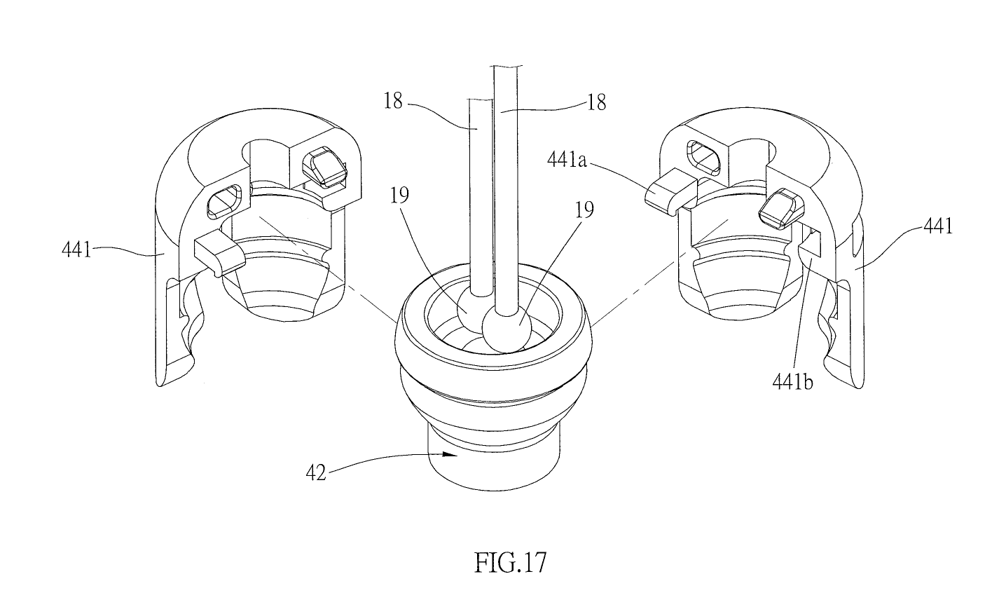

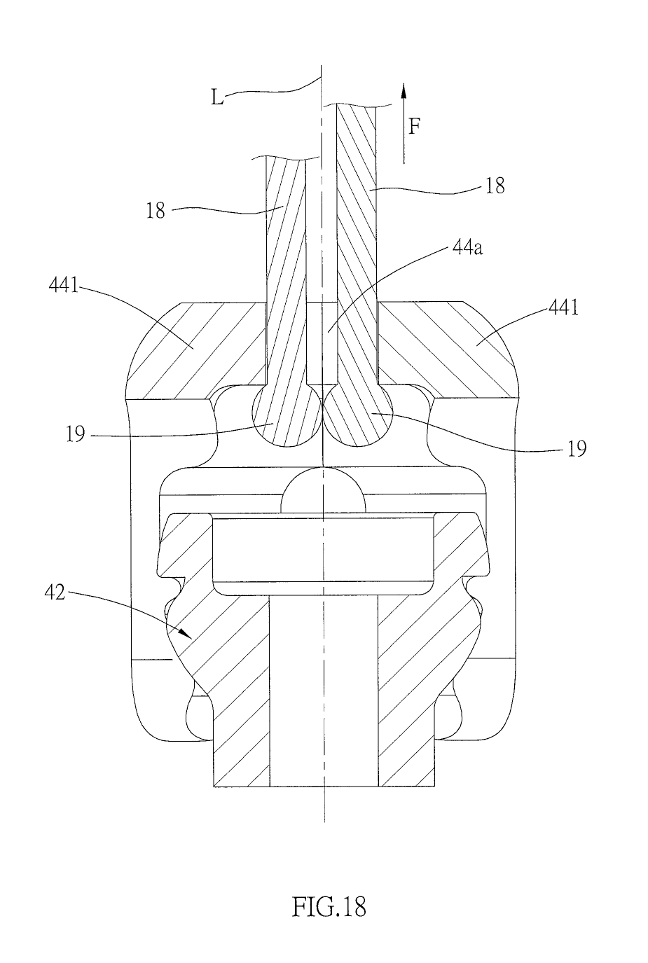

As shown in FIG. 16 to FIG. 18, the fixing unit includes a connected member 42 and a connecting member 44. The structure of the connected member 42 is the same as that of the connected member 36 shown in FIG. 12. The structure of the connecting member 44 is similar to that of the connecting member 38 shown in FIG. 12, i.e., the connecting member 44 consists of two flexible pieces 441 coupling together. In the current embodiment, each of the flexible pieces 441 of the connecting member 44 is a shell including an arc-shaped surface. The differences between the connecting member 44 and the connecting member 38 are the shape and configuration of the positioning bore, the positioning pin, the hook 441a, and the hooked portion 441b of each flexible piece 441.

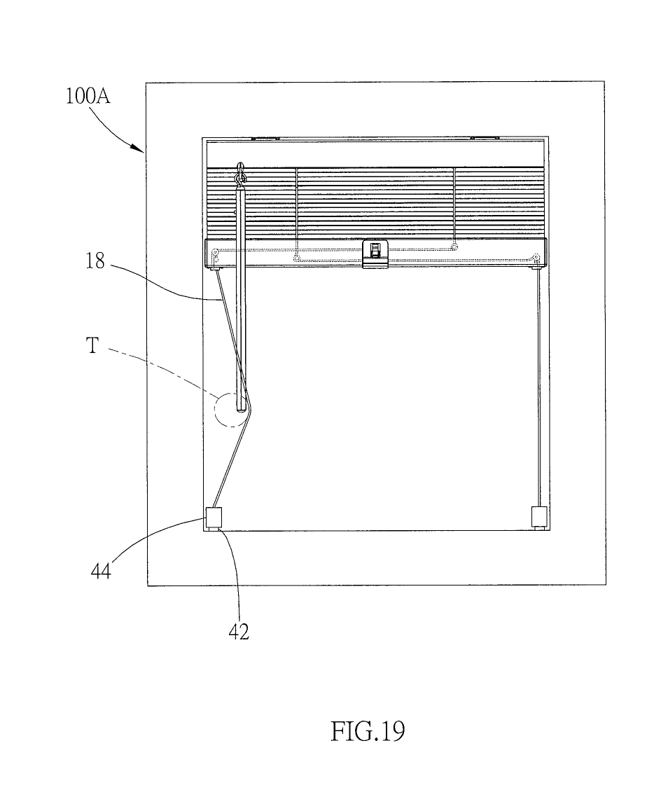

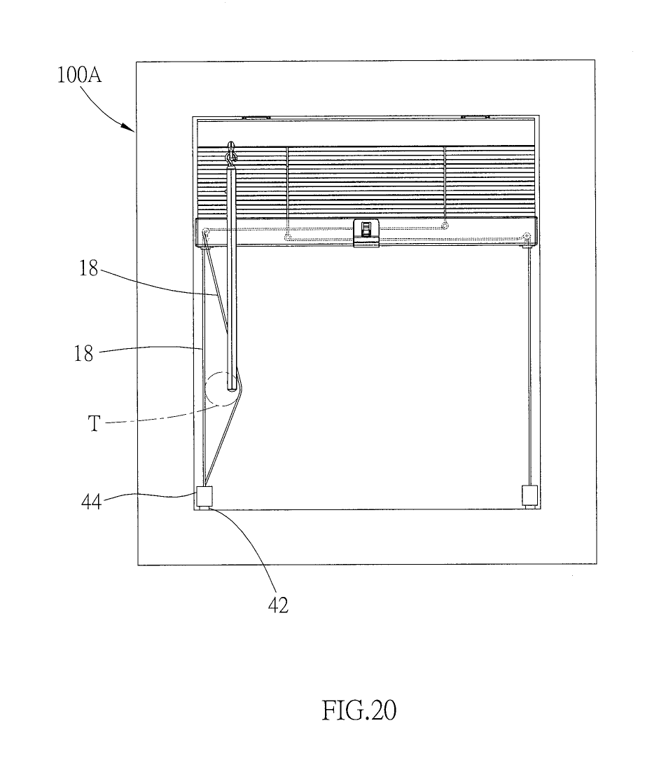

In the fourth embodiment, the number of the lifting cords 18 connected to the connecting member 44 is two but can be more than two in other embodiments according to the design requirement. The upper ends of the two lifting cords 18 are connected to the first fixture (not shown), that is, the two lifting cords 18 forces the connecting member 44 with a pull F parallel to the axis L. The two lifting cords 18 pass through the hole 44a of the connecting member 44, and cannot be detached from the connecting member 44 by the block portions 19, which keeps the lifting cords 18 taut. As illustrated in FIG. 19, if a foreign body T (e.g., child's head) is inadvertently stretched between the lifting cord 18 and the window frame 100A, the lifting cord 18 is forced to change the position, and thus the connecting member 44 is obliquely pulled up, which is similar to the state shown in FIG. 8. Furthermore, if a non-vertical pull is greater than a preset combined value between the connecting member 44 and the connected member 42, the connecting member 44 is disconnected from the connected member 42 to prevent the lifting cord 18 from wrapping around the foreign body. It is further shown in FIG. 20 that if the foreign body T is stretched between the two lifting cords 18, the connecting member 44 consisting of two flexible pieces 441 is forced by two non-vertical pulls in opposite directions, which makes the hook 441a and the corresponding hooked portion 441b detached from each other. Therefore, the flexible pieces 441 are separated from each other in the radial direction of the connecting member 44 to avoid the formation of cord loop.

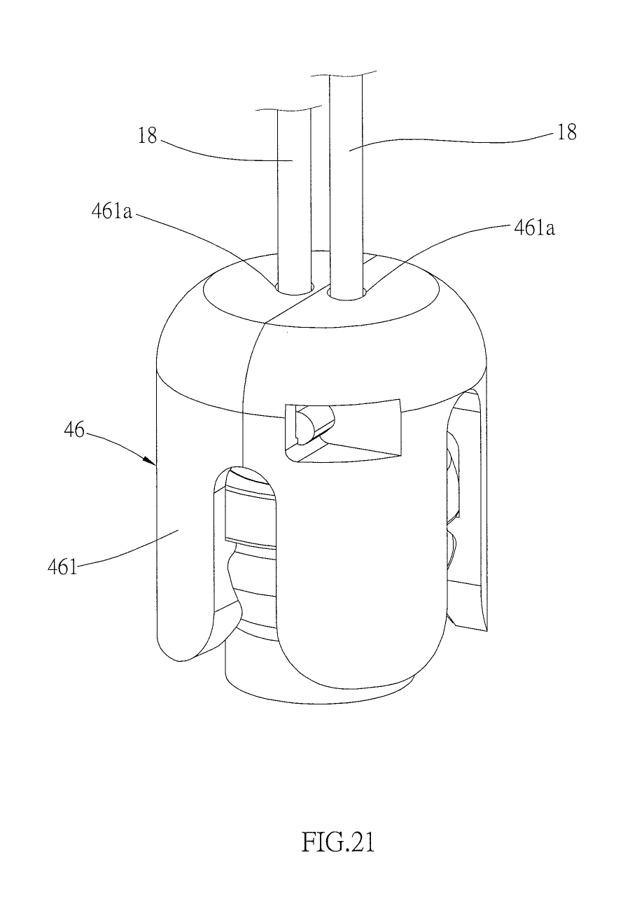

FIG. 21 shows a connecting member 46 of the fifth embodiment, which is similar to the structure illustrated in FIG. 16. The difference is that each of the two flexible pieces 461 of the connecting member 46 has a hole 461a at the top. In the current embodiment, each of the flexible pieces 461 of the connecting member 46 is a shell including an arc-shaped surface. The two lifting cords 18 respectively pass through the holes 461a of the flexible pieces 461, and cannot be detached from the flexible pieces 461 by the block portions 19. Similarly, if a foreign body is stretched between at least one of the two lifting cord 18 and the window frame 100A, the connecting member 46 is obliquely pulled up and disconnected from the connected member 48. The difference is that if the flexible pieces 461 are separated from each other in the radial direction of the connecting member 46 when the foreign body is stretched between the two lifting cords 18, the end of the lifting cord 18 is still fastened to the flexible piece 461, which prevents the flexible piece 461 from falling or losing, and is helpful for assembling the flexible pieces 461 again.

It must be pointed out that the embodiments described above are only some preferred embodiments of the present disclosure. All equivalent structures which employ the concepts disclosed in this specification and the appended claims should fall within the scope of the present disclosure.

What is claimed is:

1. A tension blind, comprising:
a covering structure;
a movable rail;
at least one lifting cord, wherein each of the at least one lifting cord is connected to a first fixture with an end thereof, and passes through the covering structure and the movable rail, and is connected to a second fixture with another end thereof;
at least one connected member, wherein each of the at least one connected member is fixed to the second fixture, and has a connected portion; and
at least one connecting member, wherein each of the at least one connecting member has a first connecting portion and a second connecting portion; the first connecting portion is connected to the another end of the at least one lifting cord; the second connecting portion is detachably connected to the connected portion.

2. The tension blind of claim 1, wherein the connected member comprises a base and a protrusion; the base is fixed to the second fixture; the protrusion is connected to the base, and has an abutted surface facing the second fixture, which constitutes the connected portion; the connecting member comprises a hollow cylinder having a wall consisting of a plurality of flexible members spaced from each other, wherein upper edges of the flexible members are connected to form the first connecting portion; each of the flexible members has an inner wall protruded inward to form an abutting surface which constitutes the second connecting portion; the abutting surface is in touch with the abutted surface of the protrusion.

3. The tension blind of claim 2, wherein the protrusion of the connected member comprises a spherical body; the abutted surface is formed on a lower part of the spherical body, and faces the base; the abutting surface of the flexible member of the connecting member is corresponding to the lower part of the spherical body, and is concave.

4. The tension blind of claim 3, wherein the protrusion of the connected member has at least one groove formed on a middle section thereof; each of the flexible members of the connecting member has a rib protruded from the inner wall, wherein the rib is embedded into the groove correspondingly.

5. The tension blind of claim 2, wherein the connected member comprises a cylinder; an outer diameter of the protrusion is greater than an outer diameter of the base, and the protrusion has the abutted surface on a bottom surface thereof; each of the flexible members of the connecting member has a hook protruded from the inner wall, wherein the hook has the abutting surface.

6. The tension blind of claim 2, wherein the upper edges of the flexible members of the connecting member are connected integrally; the connecting member has a hole at a top, and the hole constitutes the first connecting portion; each of the flexible pieces has a bottom edge which is a free end, and the flexible member can be deformed by forces.

7. The tension blind of claim 2, wherein each of the flexible members of the connecting member is a shell including an arc-shaped surface; a hole is formed at a top of the connecting member while the flexible members are detachably connected to form the connecting member, wherein the hole constitutes the first connecting portion.

8. The tension blind of claim 7, wherein the at least one lifting cord connecting to the connecting member comprises two or more lifting cords; the lifting cords pass through the hole constituting the first connecting portion; the flexible pieces are separated from each other in a radial direction thereof.

9. The tension blind of claim 2, wherein the at least one lifting cord connecting to the connecting member comprises two or more lifting cords; each of the flexible members of the connecting member comprises an arc-shaped shell, and the flexible members are detachably connected; each of the flexible members has a hole at a top to be corresponding to one of the lifting cords; the hole constitutes the first connecting portion, and is connected to the at least one lifting cord.

10. The tension blind of claim 7, wherein each of the flexible members has a connecting surface, a positioning bore recessed from the connecting surface, and a positioning pin protruding from the connecting surface; the positioning pin of one of the flexible members is inserted into the positioning bore of another one of the flexible members, and the connecting surfaces of the flexible members abut against each other.

11. The tension blind of claim 8, wherein each of the flexible members has a connecting surface, a hook, and a hooked portion; the hook of one of the flexible members is fastened to the hooked portion of another one of the flexible members, and the connecting surfaces of the flexible members abut against each other.

12. The tension blind of claim 2, further comprising at least one screw; the base of the connected member has a least one perforation; the screw passes through the perforation, and is screwed into the second fixture, wherein a head of the screw abuts against a surface of the base.

13. The tension blind of claim 2, further comprising at least one screw; the connected member has a bore recessed from a top surface of the protrusion, and has a perforation passing through the base; a diameter of the bore is greater than a diameter of the perforation; the screw passes the bore and the perforation, and is fixed into the second fixture, wherein a head of the screw abuts against a bottom surface of the bore.

14. The tension blind of claim 1, further comprising a lifting cord locking mechanism provided on the movable rail to tightly fasten the lifting cord, which is helpful for the movable rail to stop at any position along the lifting cord.

15. A tension blind, comprising:
a covering structure;
a movable rail;
at least one lifting cord, wherein each of the at least one lifting cord is connected to a first fixture with an end thereof, and passes through the covering structure and the movable rail, and is connected to a second fixture with another end thereof;
at least one connected member, wherein each of the at least one connected member is fixed to the second fixture, and has a connected portion; and
at least one connecting member having an axis, wherein each of the at least one connecting member has a first connecting portion and a second connecting portion; the first connecting portion is connected to the another end of the at least one lifting cord; if the lifting cord forces the connecting member with a pull which is not parallel to the axis, the second connecting portion is detached from the connected portion.

16. The tension blind of claim 15, wherein a portion where the at least one lifting cord is connected to the first connecting portion is on the axis; if the lifting cord forces the connecting member with a pull which is parallel or equal to the axis, the second connecting portion is not detached from the connected portion.

17. The tension blind of claim 15, wherein the connected member comprises a base and a protrusion; the base is fixed to the second fixture; the protrusion is connected to the base, and has an abutted surface facing the second fixture, which constitutes the connected portion; the connecting member comprises a hollow cylinder having a wall consisting of a plurality of flexible members spaced from each other, wherein upper edges of the flexible members are connected to form the first connecting portion; each of the flexible members has an inner wall protruded inward to form an abutting surface which constitutes the second connecting portion; the abutting surface is in touch with the abutted surface of the protrusion.

18. The tension blind of claim 17, wherein the upper edges of the flexible members of the connecting member are formed integrally; the connecting member has a hole at a top, and the hole constitutes the first connecting portion; each of the flexible pieces has a bottom edge which is a free end, and the flexible member can be deformed by forces.

19. The tension blind of claim 17, wherein each of the flexible members of the connecting member is a shell including an arc-shaped surface; a hole is formed at a top of the connecting member while the flexible members are connected to form the connecting member, wherein the hole constitutes the first connecting portion.

20. The tension blind of claim 19, wherein the at least one lifting cord connecting to the connecting member comprises two or more lifting cords; the lifting cords pass through the hole constituting the first connecting portion; the flexible pieces are separated from each other in a radial direction of the connecting member.

21. The tension blind of claim 17, wherein the at least one lifting cord connecting to the connecting member comprises two or more lifting cords; each of the flexible members of the connecting member comprises an arc-shaped shell, and the flexible members are detachably connected; each of the flexible members has a hole at a top to be corresponding to one of the lifting cords; the hole constitutes the first connecting portion, and is connected to the at least one lifting cord.

22. The tension blind of claim 15, further comprising a lifting cord locking mechanism provided on the movable rail to tightly fasten the lifting cord, which is helpful for the movable rail to stop at any position along the lifting cord.
